(19) United States
(12) Patent Application Publication
(10) Pub. No.: US 2008/0102187 A1
(43) Pub. Date: May 1, 2008

(54) Zero trans fat margarine

(76) Inventor: Asim Syed, Omaha, NE (US)

Correspondence Address: SUITER SWANTZ PC LLO, 14301 FNB PARKWAY, SUITE 220, OMAHA, NE, 68154, US

(21) Appl. No.: 11/588,854

(22) Filed: Oct. 26, 2006

(51) Int. Cl. A23D 7/00

(52) U.S. Cl. 426/603

(57) ABSTRACT

A margarine product, comprising a first fat, a second fat combined with the first fat, and an oil setting agent combined with the first fat and the second fat. The oil setting agent further comprises a mixture of polyglycerol esters of fatty acid (PGFA) and mono and di-glycerides (MDG) and an aqueous solution comprising at least 20% of the margarine. The first fat, the second fat and the oil setting agent combine to form at least 80% of the margarine product.

### FIELD OF THE INVENTION

The present invention generally relates to the field of margarine, and more particularly to a zero trans fat margarine, whereby the components of the margarine remain in suspension, resisting separation with a consistent viscosity measurement.

### BACKGROUND OF THE INVENTION

Margarine is a complex system essentially containing a mixture of triglycerides which are either crystallized or non-crystallized at ambient temperature, and aqueous ingredients. Margarine generally consists of an approximately 80% fat blend and an approximately 20% aqueous component. Minor ingredients, e.g. emulsifiers, flavors, coloring matter, vitamins etc. are dissolved or dispersed in either the fatty or the aqueous phase. Depending on the content of crystallized triglycerides in the fatty phase, the margarine is either pourable or more or less shape-retaining at ambient temperature. Since in conventional margarines the aqueous ingredients are dispersed in the form of small droplets in the fatty ingredients, margarines are generally water-in-oil type emulsions.

The trend toward hydrogenated vegetable oil yields the desire for less saturated fat. By adding hydrogen atoms to the fat molecules in vegetable oils, the unsaturated fat molecules become saturated, raising the melting point of the fat and allowing it to remain solid at room temperature. Hydrogenation typically requires the presence of a metal catalyst and temperatures of about 500° F. (260° C.) at vacuum for this reaction to take place. Naturally occurring fatty acids contain double bonds of a particular configuration, referred to as “cis-” by biochemists. These cis-bonds cause the molecules to be “bent” so that two hydrogen atoms are on the same side of the double bond. Thus, the bonds between the molecules are weaker due to their irregular shape, which results in a lower melting point. Hydrogenation causes about half of the cis-bonds in the fat molecules to reconfigure to form trans-bonds. Fats with either trans-double bonds or no double bonds (“saturated”) are solid at room temperature. Recently, it has become desirable to reduce the amount of trans fatty acids in food products, due to the ever increasing awareness of the negative health impacts of the trans fatty acids.

An additional desire is the use of semi-solid margarine. Semi-solid margarine promotes ease in handling and use and may be useful when the product is handled in container forms. Margarine is generally formed by the mixing of liquid vegetable oil with a solid fat such as hydrogenated oil. The solid fat provides the desired viscosity and the creamy appearance and texture. The liquid fat and solid fat tend to separate due to gravity during the storage. This may be especially true at ambient or room temperature. From a quality perspective this separation may be visually undesirable. Further, if a margarine also includes a solid particle flavor additive such as salt, sugar, or the like, the sold particle flavor additive may remain with the solid fat, resulting in uneven flavor and inconsistent texture.

Therefore, it would be advantageous to provide a zero trans fat margarine that resists settling and separation of the individual components.

### SUMMARY OF THE INVENTION

Accordingly, an embodiment of the present invention is directed to a zero trans fat margarine comprising a liquid fat and a solid fat combined with an oil setting agent and an up to 20% aqueous solution. The first fat is a liquid vegetable oil and the second fat is a fully hydrogenated vegetable oil. The mixture of the first fat, the second fat, and the oil setting agent form a substantially semi-solid suspension that resists separation of the components.

A further embodiment of the present invention is directed to a food product comprising a zero trans fat margarine and a nutritive ingredient. The zero trans fat margarine further comprises a first fat, a second fat and an oil setting agent, wherein the liquid oil is a liquid vegetable oil and the second oil is a fully hydrogenated vegetable oil. The mixture of the first oil, the second oil, and the oil setting agent form a substantially semi-solid suspension that resists separation of the components.

A further embodiment of the present invention is directed to a method for providing a zero trans fat margarine comprising providing a first fat, providing a second fat, and providing an oil setting agent. Method may further comprise combining the first fat, the fully hydrogenated second fat and the oil setting agent. The first fat may be a liquid vegetable oil and the second fat may be a fully hydrogenated substantially solid vegetable oil. Method may also comprise combining the first fat, second fat and oil setting agent with an aqueous solution. The mixture of the first fat, the second fat, and the oil setting agent form a substantially semi-solid suspension that resists separation of the components of the suspension. Method may also comprise providing a flavoring, lecithin, and beta-carotene and combining the flavoring, lecithin, and beta-carotene with the first fat, second fat and oil setting agent.

A further embodiment of the present invention is directed to a method for producing a food product comprising providing a first fat, providing a second fat, providing an oil setting agent and providing a nutritive product. The first fat is a liquid vegetable oil and the second fat is a fully hydrogenated vegetable oil. The mixture of the first fat, the second fat, and the oil setting agent form a substantially semi-solid suspension that resists separation of the components.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a flow chart illustrating a method for producing a zero trans fat margarine in accordance with an exemplary embodiment of the present invention;

FIG. 2 is a flow chart illustrating a method for producing a food product accordance with an additional exemplary embodiment of the present invention; and

FIG. 3 is a block diagram illustrating a system for implementing a method for producing a zero trans fat margarine in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

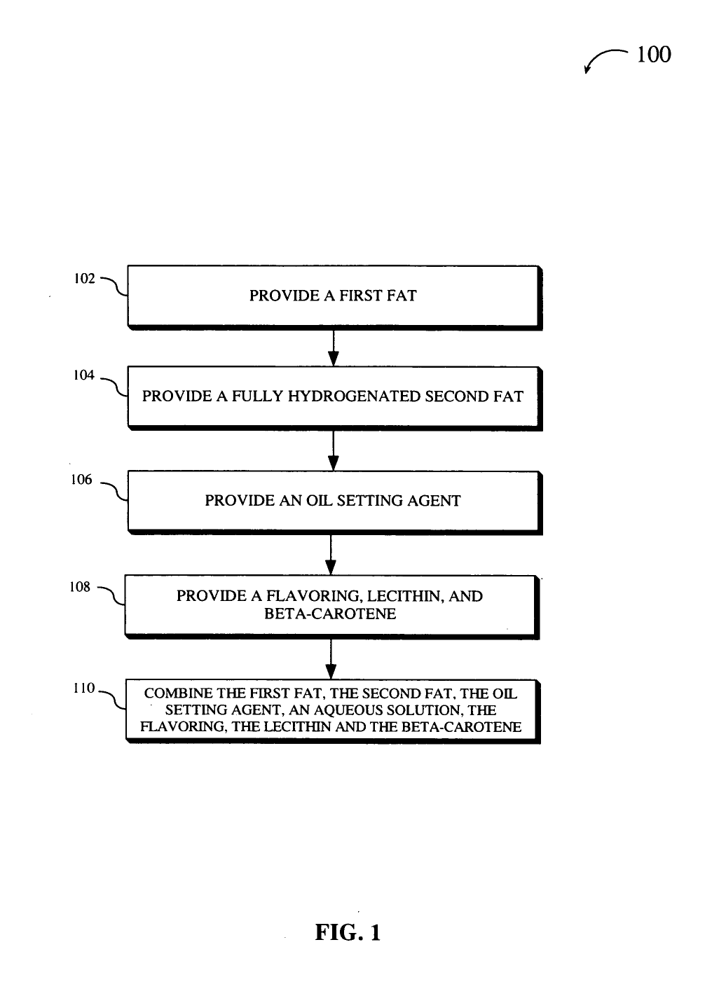

Referring generally to FIG. 1, a method 100 for producing a zero trans fat margarine product is shown. The margarine preferably comprises 15-85% of fat phase and 15-85% of aqueous phase. More preferably the margarine consists of 30-83% fat phase and 17-70% aqueous phase. In a current embodiment, the method 100 includes the steps of providing a first fat 102, providing a fully hydrogenated second fat 104, providing an oil setting agent 106, and providing flavoring, lecithin, and beta-carotene 108. Method may further comprise providing an aqueous solution suitable for blending with the first fat, second fat and oil setting agent. The resulting composition may be at least 20% aqueous. Throughout this specification, the terms “oil” and “fat” are used interchangeably, where oil generally denotes a fat in its liquid condition. Liquid oil means edible triglyceride oil which is free of solid fat at approximately 68 degrees Fahrenheit and preferably still at 59 degrees Fahrenheit, and fats may be triglycerides, either as directly obtained from a natural source (single fat), or as the product of a process such as interesterification or blending. The method 100 further comprises combining the first fat, a fully hydrogenated second fat, an oil setting agent, aqueous solution and the flavoring, lecithin, and beta-carotene into a substantially sold gel-like suspension 110 capable of suspending the solid fat and solid particle flavor additive components in the mixture. The margarine product produced via the above description results in a zero trans fat margarine that resists settling at ambient temperatures.

In a present embodiment, the invention is directed to a zero trans fat margarine. The zero trans fat margarine product includes a first fat, a second fat, salt, and a oil setting agent. In a current embodiment, the margarine is at least 80% fat. The oil setting agent may be a blend of polyglycerol esters of fatty acid (PGFA) and mono and di-glycerides (MDG). PGFAs may refer to polyglycerol esters of fatty acids are mixtures of the esters of these fatty acids with the polyglycerol mixture. The commercial products may contain mono- and di-glycerides when fats are used for transesterification with polyglycerol mixtures. A PGFA may be characterized by the chemical structure:

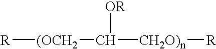

Where the average value of n is no more than 3 and R is partly a fatty acid moiety or partly hydrogen radical. PGFAs may comprise a large group of closely related compounds of complex composition. However, the individual components may be found as normal constituents of the human diet, i.e. glycerol, glycerol mono-, di- and tri-fatty acid esters and individual fatty acids, with the exceptions of the artificially produced polymers of glycerol, polymers of certain fatty acids and the actual separate esters between these polymers. It is contemplated that additional oil setting agents comprising any combination of PGFAs and and MDGs may be employed with the present invention.

The current embodiment is a zero trans fat 80% fat margarine. A zero trans fat margarine may refer to a margarine comprised of less than 0.5 grams of trans fat per 14 gram serving. The first fat may be in a proportion of up to 97% by weight of the zero trans fat margarine. The first fat is further defined as comprised of at least one of liquid soybean, canola, corn cottonseed or sunflower oil.

In the current embodiment, the second fat is substantially solid, and may be composed of at least one of fully hydrogenated soybean, canola, corn, cottonseed or sunflower fat. The margarine product may further comprise lecithin, flavoring, and coloring. It is contemplated that the margarine product may comprise less than 2% salt, soy, lecithin, natural and artificial flavors, preservatives, and coloring agents. Lecithin may refer to a phospholipid suitable for functioning as an emulsifier. Flavoring may be added to change or augment the taste of the margarine, and beta-carotene may be added to change or augment the color of the margarine. It is contemplated that any suitable emulsifier, flavoring or color modifier may be combined with the first fat, second fat and oil setting agent.

In a present embodiment, the second fat of the zero trans fat margarine product is fully hydrogenated and blended with the first fat. The first and second fat blend, when combined with an appropriate amount of a oil setting agent produces a zero trans fat margarine product which holds the fat components within a gel-like suspension matrix. Gel-like suspension matrix may be defined as a semisolid system consisting of a network of solid aggregates in which liquid is held. This gel-like suspension matrix holds the first and second fats in suspension and thus resists separation of the component fat blends while maintaining a viscosity at 800-1200 cp @ 70° F.

In further embodiments, the zero trans fat margarine product of the present invention resists separation of the component fat blends while maintaining the functionality of conventional margarine. Additionally, the zero trans fat margarine product of the present invention contains trans fat levels of less than 3% by weight of the margarine product. In a further embodiment, the zero trans fat margarine product has a saturated fat content of less than 25%.

A further embodiment is directed to a food product. The food product comprises a zero trans fat margarine product as described above and a nutritive ingredient. Specifically, the food product comprises a first fat characterized as a substantially liquid fat, a second fat characterized as substantially a solid fat. A nutritive ingredient may be any type of grain, vegetable, dairy, meat, poultry, seafood and the like suitable for combining with the margarine or suitable for use in conjunction with the margarine. For instance, the food product may be any of cookies, cakes, pie crust, bread, bread products, and other products where the use of a zero trans fat margarine product is appropriate or desirable. However, the food product may not be limited to a combination of the margarine product and a grain or processed grain. The nutritive ingredient and zero trans fat margarine product may be combined, for example via baking, cooking, freezing, refrigeration, sautéing, broiling, or frying.

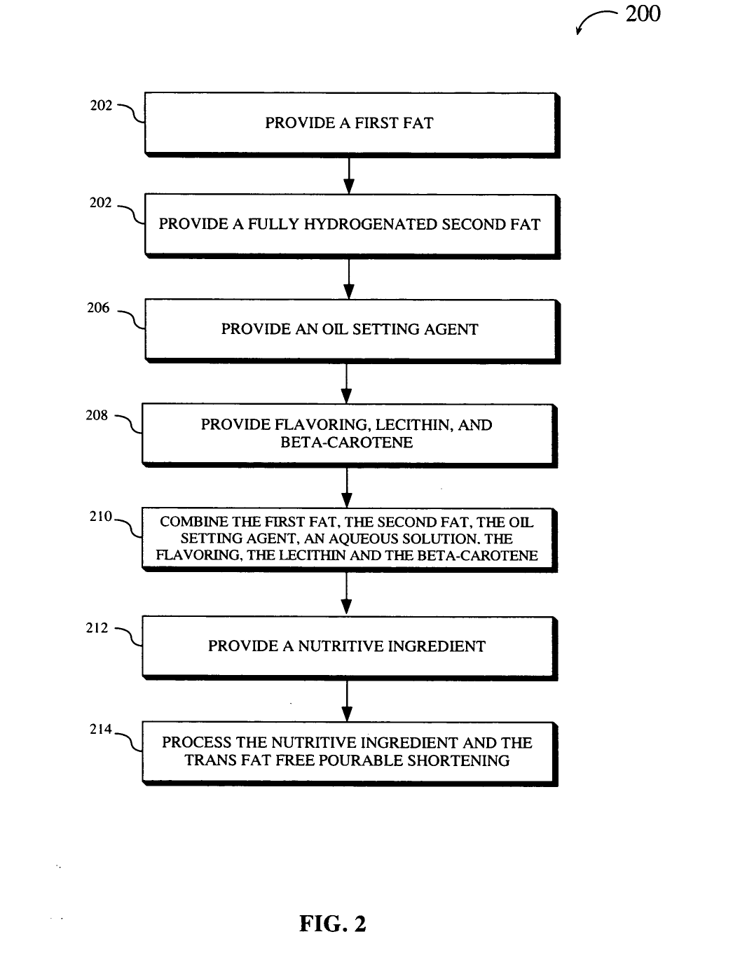

Referring generally to FIG. 2, a method 200 for producing a food product is shown. In a current embodiment, the method 200 comprises providing a first fat 202, providing a fully hydrogenated second fat 204, providing an oil setting agent 206, and providing flavoring, lecithin, and beta-carotene 208. The method further comprises combining the first fat, a fully hydrogenated second fat, an oil setting agent, and flavoring, lecithin, and beta-carotene into a substantially semi-solid suspension 210. Additionally, the method 200 may comprise providing a nutritive ingredient 212. The method 200 further comprises processing the nutritive ingredient and zero trans fat margarine product combination 214, for example via baking, cooking, freezing, refrigeration, sautéing, broiling, or frying.

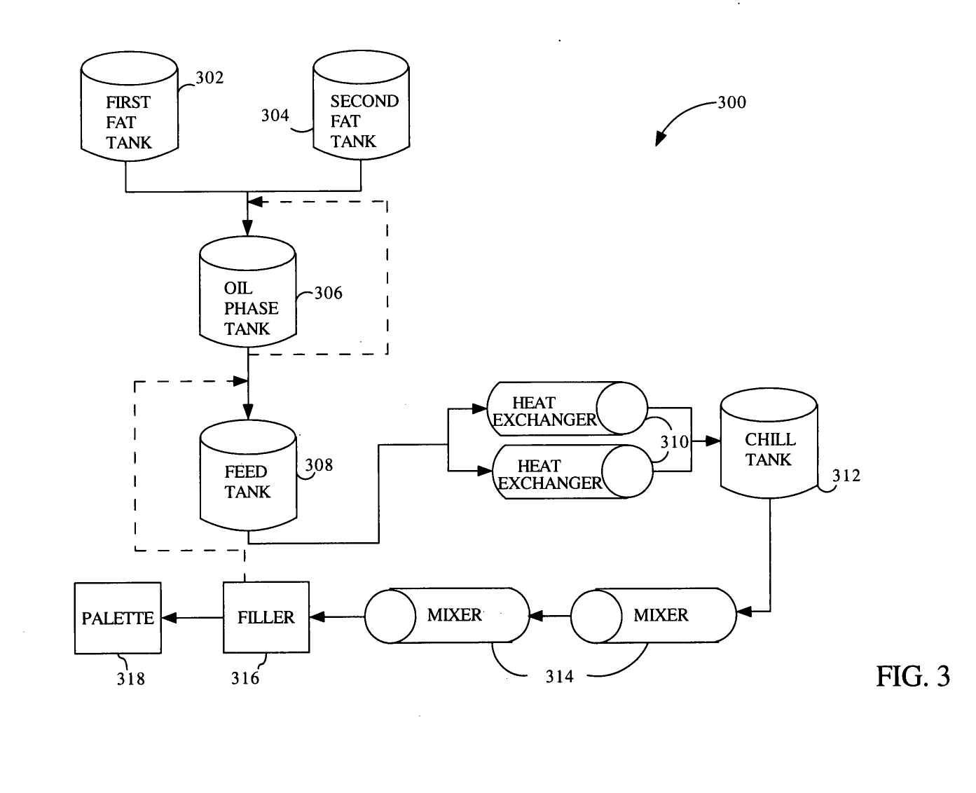

Referring generally to FIG. 3, a diagram illustrating the zero trans fat margarine product system 300 is shown. System may comprise a first fat tank 302, and a second fat tank 304. First fat tank 302 may comprise a first fat and an oil setting agent. The oil setting agent may be a blend of polyglycerol esters of fatty acid (PGFA) and mono and di-glycerides (MDG). First fat may be a liquid fat such as a liquid vegetable oil. Second fat tank 304 may comprise a second fat. Second fat may be a solid fat such as a fully hydrogenated vegetable oil. First fat, oil setting agent and second fat may be transferred to an oil phase tank 306 suitable for blending the first fat, oil setting agent and second fat. Oil phase tank may maintain the mixture at a temperature from 115-125 degrees Fahrenheit. Mixture may then be transferred to a feed tank 308, where the mixture may be maintained at approximately 120 degrees Fahrenheit. Mixture may be transferred from the feed tank 308 to at least one scraped surface heat exchanger (SSHE). An SSHE may be suitable for heating, cooling, pasteurizing, crystallizing, slush freezing, gelling or performing a like process on the mixture. The SSHE may be comprised of a jacketed cylinder with a rotating dasher holding rows of scraper blades. The mixture may be pumped through the cylinder while the heating or cooling medium is circulated between the cylinder and the jacket. The SSHE may be designed to remove the mixture continuously from the heat transfer cylinder wall. This is essential for successful heating and cooling of products that have large particulates, high viscosity, crystallize during cooling or would otherwise inhibit efficient heat transfer through fouling. The scraper blades prevent any build-up on the cylinder wall to optimize thermal exchange and run time. The SSHE may operate at approximately 100 degrees Fahrenheit. From the SSHE, the mixture may be transferred to a chill tank 312, where the temperature of the mixture may be reduced to approximately 65 degrees Fahrenheit. From the chill tank 312, mixture may be transferred to at least one mixer tank 314. Mixer tank 314 may comprise at least one mixer, and the mixer may be a 190 rotations per minute (RPM) pin mixer. It is further contemplated that mixers may be any type of mixer suitable for mixing fats and may operate at any suitable speed as desired by an operator, or as may be appropriate for mixing the components of the mixture. In an additional embodiment, mixture may be transferred directly from a SSHE tank 310 to a filler tank 316, where a filler such as lecithin may be added, and to a palette tank 318 where color may be added.

It is contemplated that an oil setting agent such as TAISET® 50K, manufactured by Taiyo International, Inc., may be utilized with the various embodiments of the present invention. TAISET® 50K may comprise a blend of polyglycerol esters of fatty acid (PGFA) and mono and di-glycerides (MDG). Oil setting agent may have an iodine value of not more than 2, a saponification value between 155-165, and acid value of not more than 4, and have a melting point between 158 degrees Fahrenheit and 169 degrees Fahrenheit. Oil setting agent may be in the form of off-white flakes or off-white solid.

In exemplary embodiments of the invention, the methods disclosed may be implemented as sets of instructions, through a single production device, and/or through multiple production devices. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not necessarily meant to be limited to the specific order or hierarchy presented.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A margarine product, comprising:
a first fat;
a second fat combined with the first fat;
an oil setting agent combined with the first fat and the second fat, the oil setting agent further comprising a mixture of polyglycerol esters of fatty acid (PGFA) and mono and di-glycerides (MDG); and
an aqueous solution comprising at least 20% of the margarine,
wherein the first fat, the second fat and the oil setting agent combine to form at least 80% of the margarine product.

2. The margarine product as claimed in claim 1, wherein the first fat is up to 97% liquid vegetable oil.

3. The margarine product as claimed in claim 2, wherein the first fat includes at least one of liquid soybean oil, canola oil, corn oil, cottonseed oil, or sunflower oil.

4. The margarine product as claimed in claim 1, wherein the second fat is fully hydrogenated and is at least one of soybean oil, canola oil, corn oil, cottonseed oil, or sunflower oil.

5. The margarine product as claimed in claim 1, further comprising less than 2% salt, soy, lecithin, natural and artificial flavors, preservatives, and coloring agents.

6. The margarine product as claimed in claim 1, further comprising less than 3% trans fat by weight.

7. The margarine product as claimed in claim 1, further comprising less than 25% saturated fat by weight.

8. The margarine product as claimed in claim 1, wherein the margarine product has a viscosity of 800-1200 cp @ 70° F.

9. A food product, comprising:
a margarine product further comprising
a first fat;
a second fat combined with the first fat;
an aqueous solution comprising at least 20% of the margarine product; and
a fat settling product combined with the first fat and the second fat; and
a nutritive ingredient combined with the first fat, the second fat and the fat settling product,
wherein the fat settling product comprises a mixture of polyglycerol esters of fatty acid (PGFA) and mono and di-glycerides (MDG) and the margarine is capable of maintaining a semi-solid consistency at ambient temperatures.

10. A food product as in claim 9, wherein the first fat comprises at least one of liquid soybean oil, canola oil, corn oil, cottonseed oil, or sunflower oil.

11. A food product as in claim 9, wherein the second fat is fully hydrogenated and comprises at least one of soybean oil, canola oil, corn oil, cottonseed oil, or sunflower oil.

12. The food product as claimed in claim 9, further comprising lecithin, beta-carotene, and flavorings composing less than 2% by weight of the zero trans fat margarine product.

13. The food product as claimed in claim 9, wherein trans fat is less than 3% by weight of the margarine product.

14. The food product as claimed in claim 9, wherein saturated fat is less than 25% by weight of the margarine product.

15. The food product as claimed in claim 9, wherein the zero trans fat margarine product viscosity is 800-1200 cp @ 70° F.

16. A method for producing a zero trans fat margarine product, comprising:
providing a first fat;
providing a fully hydrogenated second fat;
providing an aqueous solution lecithin, beta-carotene, and flavoring:
providing an oil setting agent;
combining the first fat, the second fat, the aqueous solution, lecithin, beta-carotene, and flavoring into a blend; and
adding the oil-settling agent to the blend.

17. A method as claimed in claim 16, wherein the first fat is comprises at least one of liquid soybean oil, canola oil, corn oil, cottonseed oil, or sunflower oil.

18. A method as claimed in claim 16, wherein the second fat is at least one of soybean oil, canola oil, corn oil, cottonseed oil, or sunflower oil.

19. A method as claimed in claim 16, wherein the second fat is fully hydrogenated.

20. A method as claimed in claim 16, wherein the oil setting agent is a mixture of polyglycerol esters of fatty acid (PGFA) and mono and di-glycerides (MDG)

21. A method as claimed in claim 16, further comprising less than 2% salt, soy, lecithin, natural and artificial flavors, preservatives, and coloring agents.

22. A method as claimed in claim 16, wherein the lecithin, beta-carotene, and flavoring compose less than 2% by weight of the zero trans fat margarine product.

23. A method as claimed in claim 16, wherein trans fat is less than 3% by weight of the zero trans fat margarine product.

24. A method as claimed in claim 16, wherein saturated fat is less than 25% by weight of the zero trans fat margarine product.

25. A method as claimed in claim 16, wherein the blend maintains a viscosity of 800 to 1200 cp at a temperature of approximately 70 degrees Fahrenheit.

26. A method as claimed in claim 16, wherein the aqueous solution comprises at least 20% of the margarine product.

27. A system comprising:
a first fat tank containing a first fat;
a second fat tank containing a second fat;
an auxiliary tank containing an oil setting agent;
an oil phase tank suitable for receiving and combining the first fat, the second fat and the oil setting agent into a margarine product;
a feed tank suitable for receiving the margarine product from the oil phase tank; and
at least one heat exchanger suitable for receiving the margarine product from the feed tank and processing the margarine product,
wherein the margarine comprises at least a 20% aqueous solution and maintains a viscosity of 800 to 1200 cp at a temperature of approximately 70 degrees after processing by the at least one heat exchanger.

28. The system of claim 27, wherein the oil setting agent is a blend of polyglycerol esters of fatty acid (PGFA) and mono and di-glycerides (MDG).

29. The system of claim 27, wherein the heat exchanger is a scraped surface heat exchanger.

30. The system of claim 27, further comprising a chill tank suitable for reducing the temperature of the margarine product.

31. The system of claim 27, further comprising at least one mixer tank suitable for receiving the margarine product from the heat exchanger and mixing the margarine product.

32. The system of claim 27, further comprising a filler tank suitable for adding a filler to the margarine product.

33. The system of claim 27, further comprising a palette tank suitable for adding coloring to the margarine product.
